(19) United States
(12) Patent Application Publication
(10) Pub. No.: US 2026/0254551 A1
(43) Pub. Date: Aug. 27, 2026

(54) Optical Distribution Node, Communication Network Node and Communication Network

(71) Applicant: Telefonaktiebolaget LM Ericsson (publ), Stockholm (SE)

(72) Inventors: Fabio Cavaliere, Pisa (IT); Luca Giorgi, Pisa (IT); Alessandra Bigongiari, Pisa (IT)

(21) Appl. No.: 18/870,125

(22) PCT Filed: Jun. 1, 2022
(86) PCT No.: PCT/EP2022/064982

§ 371 Date: Nov. 27, 2024

(51) Int. Cl. H04J 14/02

(52) U.S. Cl. CPC H04J 14/0213; H04J 14/0208; H04J 14/0216

(57) ABSTRACT

An optical distribution node, ODN, 100 comprises downstream, DS, optical routing apparatus (110) and upstream, US, optical routing apparatus 120. The DS optical routing apparatus comprises DS output ports (112) and a DS input port (114) for receiving wavelength division multiplexed, WDM, DS channels having a first channel spacing. The DS optical routing apparatus (110) is configured to distribute the WDM DS channels into WDM DS channel sub-sets, the WDM DS channels in the sub-sets are non-contiguous and have larger channel spacing, and to route WDM DS channel sub-sets to different DS output ports. The US optical routing apparatus (120) comprises a US output port (122) and US input ports (124) for receiving WDM US channel sub-sets of WDM US channels, the WDM US channels in the sub-sets are non-contiguous and have the larger channel spacing. The US optical routing apparatus is configured to combine the WDM US channel sub-sets, the combined WDM US channels have the first channel spacing, and to route the combined WDM US channels to the US output port.

### TECHNICAL FIELD

The invention relates to a communication network optical distribution node and to a communication network node. The invention further relates to a communication network comprising the optical distribution network node and the communication network node. The invention further relates to a method of routing optical channels in a communication network.

### BACKGROUND

The usage of new spectrum and the increase of user connection speed will lead to an increase of capacity of the fronthaul links in radio access networks, RAN, from several tens to several hundred Gbit/s. In one network scenario a number of antenna sites are connected to a baseband site by means of 400G optical links provided by an optical distribution node. This can be achieved by means of high speed optical transmission on a single optical carrier (e.g. 400G, according to the 400ZR OIF standard), dense wavelength division multiplexing, DWDM, transmission or a combination of both. Higher capacity, for example 800 Gbit/s or more, will be required in future and this may be achieved using higher speed optical interfaces, DWDM or both. DWDM enables high aggregate capacity to be achieved on an optical link. Current DWDM systems aggregate up to 48 optical channels, 100 GHz spaced in the C band (1530-1565 nm) or 96 channels, 50 GHz spaced, onto a single optical fibre.

Typical values of channel bit rate for each channel in a fronthaul link are: 2.5 Gbit/s in legacy systems that will be dismissed; 10 Gbit/s in legacy systems that are widely installed but no longer upgraded; 25 Gbit/s in current systems; 40 Gbit/s (but this is seldom used); 100 Gbit/s and 400 Gbit/s for next generation systems. 2.5 Gbit/s, 10 Gbit/s and 25 Gbit/s channel bit rate systems use intensity modulated-direct detection, IM-DD, optical interfaces and an on-off keying, OOK, modulation format. Different options exist for 40 Gbit/s channel bit rate systems, for example IM-DD with duobinary modulation, dual polarisation quadrature shift keying, DPQSK, with direct detection, or coherent DP-QPSK, but none have been able to achieve a significant market share before the advent of 100 Gbit/s channel bit rate systems. 100 Gbit/s channel bit rate systems use a coherent optical interface with DP-QPSK modulation. 400 Gbit/s channel bit rate systems use a coherent optical interface with dual polarisation 16 quadrature amplitude modulation, DP-16QAM.

Before being transmitted in optical fibre, the fronthaul signal undergoes electrical to optical, EO, conversion. The Application Specific Integrated Circuits, ASICs, used to perform this in current RAN equipment have a 25 Gbit/s electrical interface that can be directly mapped onto a 25 Gbit/s optical interface. Alternatively, 4 or 16 25 Gbit/s electrical signals can be aggregated into a single 100 Gbit/s or 400 Gbit/s optical signal, respectively. Next generation ASICs will have a 50 Gbit/s electrical interface, still suitable to be aggregated onto a single 100 Gbit/s or 400 Gbit/s optical signal but with no direct mapping option onto a 50 Gbit/s DWDM optical interface.

Optical coherent interfaces like 100 Gbit/s and 400 Gbit/s have no practical distance and attenuation limitations for fronthaul applications but they are very expensive, which prevented so far their use in that segment. Moreover, aggregating electrical 25 Gbit/s or 50 Gbit/s signals into a single 100 Gbit/s or 400 Gbit/s optical signals requires “gearboxes” that consume power and introduce latency. In addition, 100 Gbit/s and 400 Gbit/s optical pluggable modules may have a form factor bigger than the one used in RAN equipment (e.g., a radio unit) requiring the use of an external transponder unit that further exacerbates the problem.

Direct mapping an electrical signal generated by an ASIC into an optical channel at the same bit rate would not require gearboxes and would be very energy efficient. Today, for example, 25 Gbit/s I/O ASICs are connected to 25 Gbit/s SFP28 optical modules directly plugged into RAN equipment, with no use of transponders. It would be ideal to replicate the same situation with next generation 50 Gbit/s I/O ASICs and future higher speed generations, but it is not so simple. DWDM is a way to obtain high aggregate capacity but current DWDM systems work in C band, where the achievable distance of direct detection optical interfaces at 50 Gbit/s or higher bit rate is severely limited by fibre chromatic dispersion. This is an issue that is not easy to solve, as discussed in P. Iovanna et al., “Optical Technology for NFV Converged Networks”, Applied Sciences, 2021, 11(4), page 1522. Nevertheless, direct detect solutions, cost competitive with respect to coherent optics, exist as reported in E. Forestieri et al., “2. High-Speed Optical Communications Systems for Future WDM Centralized Radio Access Networks”, J. Lightwave Technol., vol. 40, issue 2, 15 Jan. 2022, pages 368-378.

### SUMMARY

It is an object to provide an improved communication network optical distribution node. It is a further objection to provide an improved communication network node. It is a further objection to provide an improved communication network. It is a further objection to provide an improved method of routing optical channels in a communication network.

An aspect provides a communication network optical distribution node, ODN, comprising downstream, DS, optical routing apparatus and upstream, US, optical routing apparatus. The DS optical routing apparatus comprises a plurality of DS output ports and a DS input port. The DS input port is for receiving wavelength division multiplexed, WDM, DS channels having a first channel spacing. The DS optical routing apparatus is configured to distribute the WDM DS channels into a plurality of WDM DS channel sub-sets of WDM DS channels and to route WDM DS channel sub-sets to different DS output ports. The WDM DS channels in the WDM DS channel sub-sets are non-contiguous and have a second, larger channel spacing. The US optical routing apparatus comprising a US output port and a plurality of US input ports. The US input ports are for receiving WDM US channel sub-sets of WDM US channels. The WDM US channels in the WDM US channel sub-sets are non-contiguous and have the second channel spacing. The US optical routing apparatus is configured to combine the WDM US channel sub-sets and to route the combined WDM US channels to the US output port. The combined WDM US channels have the first channel spacing.

The optical distribution node in the DS direction may advantageously map densely spaced downstream DWDM channels coming from a baseband hub into different sub-sets of more widely spaced downstream channels. Each sub-set may then distributed to a different node or antenna site. In the US direction, the ODN may advantageously aggregate sub-sets of widely spaced DWDM channels coming from different nodes or antenna sites into a single comb of more densely spaced upstream channels. The ODN may be applicable to DWDM systems in O band and may be compatible with an increase of bit rate from 50 to 100 Gbit/s. The ODN may enable low latency in a communication network because it does not require use of gearboxes for electrical signal aggregation.

In an embodiment, the DS optical routing apparatus comprises a band splitter and a first optical filter device. The band splitter comprises the DS input port and the band splitter is configured to split the WDM DS channels into a first plurality (M) of wavelength bands. Each wavelength band comprises a second plurality (N) of WDM DS channels. The first optical filter device comprises said second plurality (N) of DS output ports and said first plurality (M) of inputs ports. The first optical filter input ports are for receiving different bands of said first plurality of wavelength bands. The first optical filter device is configured to distribute the WDM DS channels of each wavelength band into the plurality of WDM DS channel sub-sets. Each WDM DS channel sub-set is output from a different output port of the second plurality of DS output ports. The channel routing performed by the band splitter and first optical filter device advantageously causes the WDM DS channels in the WDM DS channel sub-sets to be non-contiguous and to have the second, larger channel spacing.

In an embodiment, the second plurality of WDM DS channels in each wavelength band are contiguous DS channels. This advantageously ensures that the WDM DS channel sub-sets are non-contiguous and have the second, larger channel spacing.

In an embodiment, the first optical filter device is a first cyclic arrayed waveguide grating, AWG. This advantageously ensures that the WDM DS channel sub-sets are non-contiguous and have the second, larger channel spacing.

In an embodiment, the band splitter is a 1:8 band splitter configured to receive 24 WDM DS channels and to split the 24 WDM DS channels into 8 wavelength bands of 3 WDM DS channels. The first cyclic AWG is an 8×8 cyclic AWG configured to distribute the 3 WDM DS channels of each wavelength band into 3 WDM DS channel sub-sets. The 3 WDM DS channel sub-sets are output from different output ports of 3 DS output ports of the 8×8 cyclic AWG. The combination of a 1:8 band splitter and an 8×8 cyclic AWG advantageously ensures that 24 WDM DS channels are distributed into three sub-sets of non-contiguous DS channels with a wide channel spacing equivalent to three times the first channel spacing, each output from a different DS output port.

In an embodiment, the US optical routing apparatus comprises a second optical filter device and a band combiner. The second optical filter device comprises said first plurality (M) of output ports and said second plurality (N) of US input ports. The US input ports are for receiving the WDM US channel sub-sets. The second optical filter device is configured to distribute the WDM US channels of each WDM US channel sub-set into different wavelength bands of said first plurality of wavelength bands. Each wavelength band comprises said second plurality of WDN US channels having the first channel spacing. Each wavelength band is output from a different output port of the first plurality of output ports. The band combiner comprises said US output port and said first plurality (M) of input ports. The band combiner input ports are for receiving the wavelength bands and the band combiner is configured to combine the wavelength bands and the combined WDM US channels are output from the US output port. The combined US channels have the first channel spacing. The channel routing performed by the band combiner and second optical filter device advantageously causes non-contiguous WDM US channels in the WDM DS channel sub-sets to be combined into a set of contiguous US channels having the first channel spacing.

In an embodiment, the second plurality of different WDM US channels in each wavelength band are contiguous US channels. This advantageously ensures that the combined set of US channels are contiguous channels having the first channel spacing.

In an embodiment, the second optical filter device is a second cyclic arrayed waveguide grating, AWG. This advantageously ensures that the WDM US channels in each wavelength band are contiguous US channels.

In an embodiment, the second cyclic AWG is an 8×8 cyclic AWG configured to receive 3 WDM US channel sub-sets of 8 WDM US channels at 3 different US input ports. The 8×8 cyclic AWG is configured to distribute the 8 WDM US channels of each WDM US channel sub-set into 8 different wavelength bands. Each wavelength band comprises 3 different WDM US channels. The band combiner is an 8:1 band combiner configured to combine the 8 wavelength bands and output the combined WDM US channels.

The combination of an 8×8 cyclic AWG and a 1:8 band combiner advantageously ensures that 24 WDM US channels within three sub-sets of non-contiguous US channels with a wide channel spacing equivalent to three times the first channel spacing, each received at a different US input port, are combined into a comb of 24 contiguous WDM US channels having the first channel spacing.

In an embodiment, the WDM DS channels are ODD channels of a wavelength grid and the WDM US channels are EVEN channels of the wavelength grid. The first optical filter device is configured to distribute a first, ODD channel to a first DS output port and the second optical filter device is configured to receive a second, adjacent EVEN channel from an equivalent first US input port. The downstream and upstream channels at DS output port/US input port pairs, for example at the same node or antenna site, are thus contiguous, which may advantageously minimize asymmetries in propagation delay.

In an embodiment, the WDM DS channels are ODD channels of a wavelength grid and the WDM US channels are EVEN channels of the wavelength grid. The ODN further comprises an optical combiner configured to combine the WDM DS channels having the first channel spacing and the WDM US channels having the first channel spacing. The combined channels have a third channel spacing, lower than the first channel spacing. The WDM US and DS channels may therefore advantageously counter propagate on a single optical fibre with a smaller channel spacing.

Corresponding embodiments and advantages also apply to the communication network and the method described below.

An aspect communication network node comprising a downstream, DS, input port, an upstream, US, output port, a plurality of drop ports, a plurality of add ports and add/drop routing apparatus. The DS input port is for receiving a wavelength division multiplexed, WDM, DS channel sub-set of non-contiguous WDM DS channels. The add ports are for receiving non-contiguous WDM US channels. The add/drop routing apparatus is configured to route WDM DS channels from the DS input port to different drop ports and is configured to route WDM US channels from different add ports to the US output port.

By receiving only non-contiguous WDM DS channels and non-contiguous WDM US channels, the node may be constructed using pluggable small form factor devices hosting simple channel add/drop routing apparatus.

In an embodiment, the add/drop routing apparatus comprises a plurality of optical drop couplers and a plurality of optical add couplers. The optical drop couplers are connected between the DS input port and different drop ports. The optical drop couplers are configured to drop different DS channels to different drop ports. The optical add couplers are connected between the US output port and different add ports. The optical add couplers are configured to add different US channels received from different add ports. By receiving only non-contiguous WDM DS channels and non-contiguous WDM US channels, the node may be constructed using pluggable small form factor devices hosting simple channel add/drop couplers.

In an embodiment, the optical drop couplers and the optical add couplers are micro-ring resonators, MRR. The add/drop routing apparatus further comprises an optical bus waveguide extending from the DS input port to the US output port, a plurality of drop waveguides connected to different drop ports and a plurality of add waveguides connected to different add ports. The optical drop couplers are configured to couple different DS channels input into the optical bus waveguide from the DS input port from the optical bus waveguide into different drop waveguides. The optical add couplers are configured to add different US channels received at different add ports from different add waveguides into the optical bus waveguide for output from the US output port. By receiving only non-contiguous WDM DS channels and non-contiguous WDM US channels MRR may advantageously be used as optical add couplers and optical drop couplers, providing both wavelength selection and wavelength tuning functionality. In addition, the wider channel spacing that non-contiguous WDM channels have enables a relaxation of the free spectral range, FSR, constraints applied to the MRR since the US/DS channels at the node are distributed in well distanced pairs of channels. This is because it is not necessary for the second resonance of the MRR to lie outside the wavelength range covered by the US/DS channels but rather the pairs of channels are sufficiently well distanced that the second resonance can be accommodated between two pairs of US/DS channels.

In an embodiment, the WDM DS channels and WDM US channels have wavelengths within a channels wavelength range. The MRRs are configured to have wavelength responses comprising first resonance peaks at wavelengths of different DS channels or US channels and the MRRs are configured to have a free spectral range, FSR, such that the wavelength responses have second resonance peaks at one of wavelengths outside the channels wavelength range or wavelengths between wavelengths of contiguous pairs of DS channels and US channels. The wider channel spacing that non-contiguous WDM channels have enables a relaxation of the free spectral range, FSR, constraints applied to the MRR since the US/DS channels at the node are distributed in well distanced pairs of channels. Advantageously, because the pairs of channels are sufficiently well distanced, the second resonance of the MRR can lie outside the wavelength range covered by the US/DS channels or it can be accommodated between two pairs of US/DS channels.

In an embodiment, the add/drop routing apparatus comprises an optical splitter connecting the DS input port to the drop ports and an optical coupler connecting the add ports to the US output port. Advantageously, the add/drop routing apparatus does not require any wavelength selective device, which is instead provided at an optical transceiver receiving/transmitting an add/drop pair of DS/US channels. The add/drop apparatus advantageously has a small footprint and is compatible with standard production lines of CMOS electronics.

In an embodiment, the add/drop routing apparatus comprises a photonic integrated circuit. By receiving only non-contiguous WDM DS channels and non-contiguous WDM US channels, the node may be constructed using pluggable small form factor devices hosting simple integrated photonic circuits for channel add/drop.

Corresponding embodiments and advantages also apply to the communication network and method described below.

An aspect provides a method of routing optical channels in a communication network. The method comprises downstream operations of receiving wavelength division multiplexed, WDM, downstream, DS, channels and distributing the WDM DS channels into a plurality of WDM DS channel sub-sets of WDM DS channels. The received WDM DS channels have a first channel spacing. The WDM DS channels in the WDM DS channel sub-sets are non-contiguous and have a second, larger channel spacing. The method additionally comprises upstream operations of receiving WDM upstream, US, channel sub-sets of WDM US channels and combining the WDM US channel sub-sets. The WDM US channels in the received WDM US channel sub-sets are non-contiguous and have the second channel spacing. The combined WDM US channels have the first channel spacing.

In an embodiment, the method further comprises combining the WDM DS channels having the first channel spacing and the WDM US channels having the first channel spacing. The combined channels have a third channel spacing, lower than the first channel spacing.

An aspect provides a communication network comprising a baseband hub, a communication network ODN, a single fibre optical link connecting the baseband unit to the ODN, a plurality of communication network nodes, downstream, DS, optical fibres connecting DS output ports of the ODN to different communication network nodes, and upstream, US, optical fibres connecting communication network nodes to different US input ports of the ODN. The ODN comprises downstream, DS, optical routing apparatus and upstream, US, optical routing apparatus. The DS optical routing apparatus comprises a plurality of DS output ports and a DS input port. The DS input port is for receiving wavelength division multiplexed, WDM, DS channels having a first channel spacing. The DS optical routing apparatus is configured to distribute the WDM DS channels into a plurality of WDM DS channel sub-sets of WDM DS channels and to route WDM DS channel sub-sets to different DS output ports. The WDM DS channels in the WDM DS channel sub-sets are non-contiguous and have a second, larger channel spacing. The US optical routing apparatus comprising a US output port and a plurality of US input ports. The US input ports are for receiving WDM US channel sub-sets of WDM US channels. The WDM US channels in the WDM US channel sub-sets are non-contiguous and have the second channel spacing. The US optical routing apparatus is configured to combine the WDM US channel sub-sets and to route the combined WDM US channels to the US output port. The combined WDM US channels have the first channel spacing. The communication network nodes comprises a downstream, DS, input port, an upstream, US, output port, a plurality of drop ports, a plurality of add ports and add/drop routing apparatus. The DS input port is for receiving a wavelength division multiplexed, WDM, DS channel sub-set of non-contiguous WDM DS channels. The add ports are for receiving non-contiguous WDM US channels. The add/drop routing apparatus is configured to route WDM DS channels from the DS input port to different drop ports and is configured to route WDM US channels from different add ports to the US output port.

Embodiments of the invention will now be described, by way of example only, with reference to the accompanying drawings.

### BRIEF DESCRIPTION OF THE DRAWINGS

FIGS. 1 to 6 are block diagrams illustrating embodiments of a communication network optical distribution node;

FIGS. 7 to 9 are block diagrams illustrating embodiments of a communication network remote node;

FIG. 10 illustrates the free spectral range, FSR, of the add/drop filters of an embodiment of a communication network remote node;

FIG. 11 is a block diagram illustrating an embodiment of a communication network; and

FIGS. 12 and 13 are flowcharts illustrating embodiments of method steps.

### DETAILED DESCRIPTION

The same reference numbers will be used for corresponding features in different embodiments.

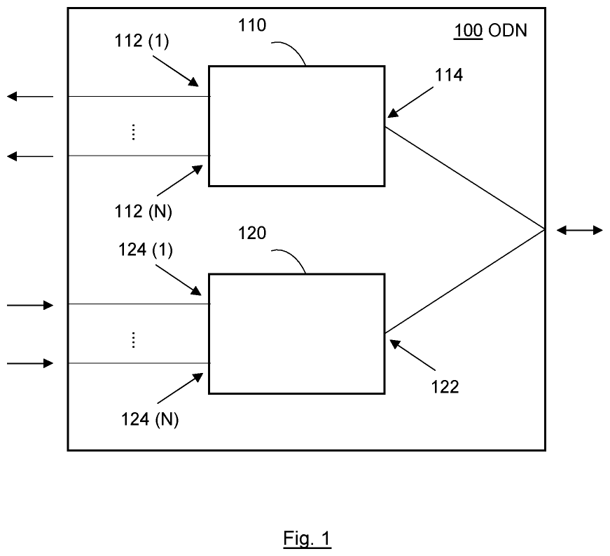

Referring to FIG. 1, an embodiment provides a communication network optical distribution node, ODN, 100 comprising downstream, DS, optical routing apparatus 110 and upstream, US, optical routing apparatus 120.

The DS optical routing apparatus 110 comprises a DS input port 114 for receiving wavelength division multiplexed, WDM, DS channels. The received WDM DS channels have a first channel spacing. The DS optical routing apparatus also comprises a plurality, N, of DS output ports 112.

The DS optical routing apparatus 110 is configured to distribute the WDM DS channels into a plurality of WDM DS channel sub-sets. Each sub-set comprises a different sub-set of the WDM DS channels. The WDM DS channels in each WDM DS channel sub-set are non-contiguous and have a second channel spacing, larger than the first channel spacing. The DS optical routing apparatus is additionally configured to route the WDM DS channel sub-sets to different DS output ports 12.

The US optical routing apparatus 120 comprises a plurality of US input ports 124 for receiving WDM US channel sub-sets of WDM US channels. The WDM US channels in the WDM US channel sub-sets are non-contiguous and have the second channel spacing. The US optical routing apparatus is configured to combine the WDM US channel sub-sets. The combined WDM US channels have the first channel spacing.

The US optical routing apparatus 120 also comprises a US output port 122. The US optical routing apparatus is additionally configured to route the combined WDM US channels to the US output port.

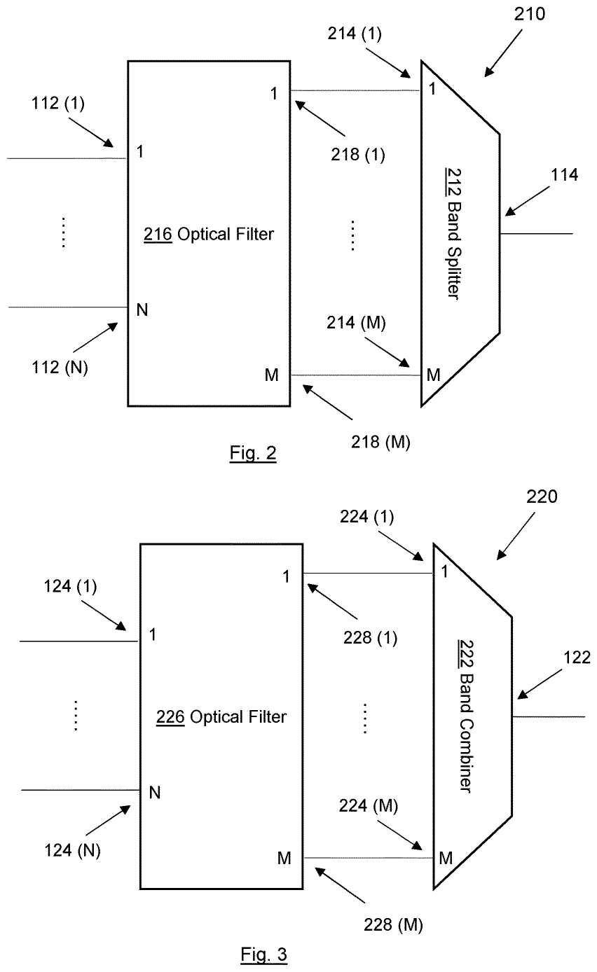

FIG. 2 illustrates the DS optical routing apparatus 210 of a communication network ODN according to another embodiment. The DS optical routing apparatus 210 comprises a band splitter 212 and a first optical filter device 216.

The band splitter 212 comprises the DS input port 114 and a first plurality, M, of output ports 214. The band splitter 212 is configured to split the WDM DS channels into said first plurality, M, of wavelength bands. Each wavelength band comprises a second plurality, N, of WDM DS channels. Each of the M wavelength bands is output from a different one of the M output ports.

The first optical filter device 216 comprises said first plurality, M, of inputs ports 218 for receiving different bands of said first plurality of wavelength bands. The first optical filter device 216 also comprises said second plurality, N, of DS output ports 112. The first optical filter device is configured to distribute the WDM DS channels of each wavelength band, received at a respective input port 218, into said second plurality, N, of WDM DS channel sub-sets. Each of the N WDM DS channels in a wavelength band, received at a respective input port 218, is distributed into a different one of the N WDM DS channel sub-sets. The WDM DS channels in each WDM DS channel sub-set are therefore non-contiguous DS channels. The first optical filter device is configured to output each WDM DS channel sub-set from a different output port of the second plurality, N, of DS output ports 12.

In an embodiment, the second plurality, N, of WDM DS channels in each wavelength band are contiguous DS channels. The band splitter 212 is configured to split M.N contiguous WDM DS channels into M wavelength bands, each wavelength band comprising N contiguous WDM DS channels.

In an embodiment, the first optical filter device is a first cyclic arrayed waveguide grating, AWG.

FIG. 3 illustrates the US optical routing apparatus 220 of a communication network ODN according to another embodiment. The US optical routing apparatus 220 comprises a band combiner 222 and a second optical filter device 226.

The second optical filter device 226 comprises said second plurality, N, of US input ports 124, for receiving the WDM US channel sub-sets having the second channel spacing. The second optical filter device is configured to distribute the first plurality, M, of WDM US channels of each WDM US channel sub-set, received at the US input ports, into different wavelength bands of said first plurality, M, of wavelength bands. Each of the M WDM US channels in a channel sub-set, received at a respective US input port 124, is distributed into a different one of the M wavelength bands. Each wavelength band comprises said second plurality, N, of WDM US channels having the first channel spacing.

The second optical filter device 226 additionally comprises said first plurality, M, of output ports 228. The second optical filter device is configured to output each wavelength band from a different output port of the first plurality, M, of output ports.

The band combiner 222 comprises said first plurality, M, of input ports 224 for receiving the M wavelength bands. The band combiner is configured to combine the M wavelength bands, the combined US channels having the first channel spacing. The band combiner 222 additionally comprises the US output port 122 and the band combiner is configured to output the combined WDM US channels from the US output port.

In an embodiment, the second plurality of different WDM US channels in each wavelength band are contiguous US channels. The band combiner 222 is configured to combine M wavelength bands, each comprising N contiguous US channels, into a combined M.N contiguous WDM US channels.

In an embodiment, the second optical filter device is a second cyclic arrayed waveguide grating, AWG.

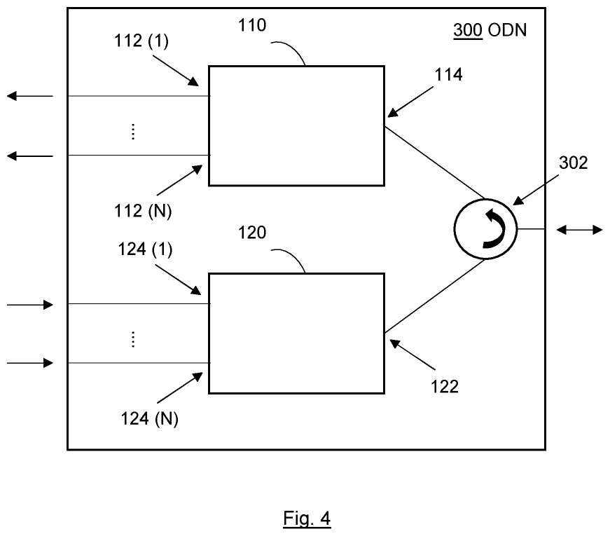

In an embodiment, illustrated in FIG. 4, the communication network ODN 300 additionally comprises an optical combiner, in this embodiment an optical circulator 302. The optical circulator is configured to combine the WDM DS channels having the first channel spacing and the WDM US channels having the first channel spacing. The combined channels have a third channel spacing, lower than the first channel spacing.

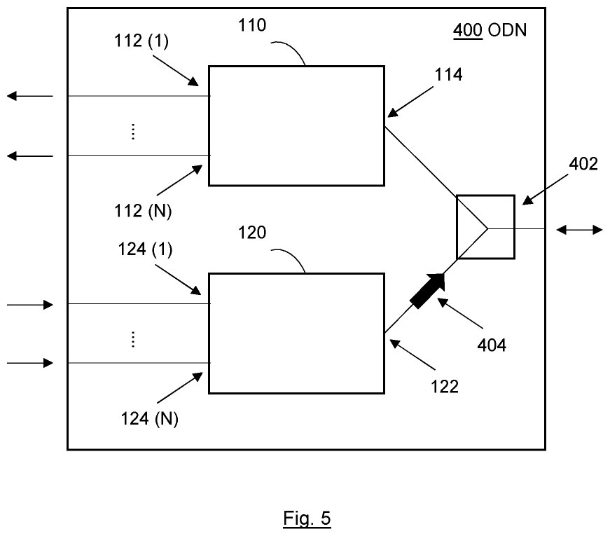

In an embodiment, illustrated in FIG. 5, the communication network ODN 400 additionally comprises an optical combiner, in this embodiment an optical splitter 402 and an optical isolator 404. The optical splitter is configured to combine the WDM DS channels having the first channel spacing and the WDM US channels having the first channel spacing. The combined channels have a third channel spacing, lower than the first channel spacing.

WDM US channels received from the US optical routing apparatus 120 pass through the optical isolator 404 and are combined with the WDM DS channels by the optical splitter. WDM DS channels received at the optical splitter are power split and routed towards both the DS optical routing apparatus 110 and the US optical routing apparatus 120 but are blocked from reaching the US optical routing apparatus by the optical isolator.

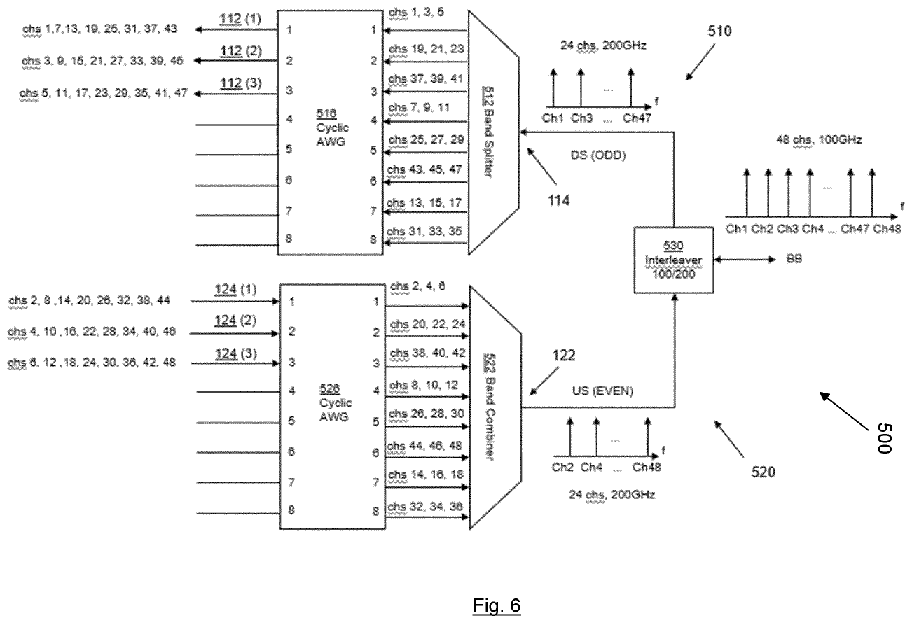

FIG. 6 illustrates a communication network optical distribution node, ODN, 600 according to an embodiment. The ODN comprises DS optical routing apparatus 510, US optical routing apparatus 520 and an optical combiner 530.

The DS optical routing apparatus 510 comprises a band splitter 512 and a first optical filter 516. The US optical routing apparatus 520 comprises a second optical filter 526 and a band combiner 522.

The band splitter 512 is a 1:8 band splitter and comprises the DS input port 114 and 8 output ports 214. The band splitter 512 is configured to receive 24 WDM DS channels at the DS input port and to split the 24 WDM DS channels into 8 wavelength bands of 3 WDM DS channels. Each of the 8 wavelength bands is output from a different one of the 8 output ports of the band splitter. The first optical filter is a first 8×8 cyclic AWG 516, having 8 input ports and 8 output ports. It is configured to receive the 8 wavelength bands output from the band splitter at its 8 input ports and it is configured to distribute the 3 WDM DS channels of each wavelength band into 3 different WDM DS channel sub-sets. The WDM DS channels in each WDM DS channel sub-set are therefore non-contiguous DS channels. The 3 WDM DS channel sub-sets are output from output ports 1 to 3 of the 8×8 cyclic AWG, which form the DS output ports of the DS optical routing apparatus.

The second optical filter 526 is a second 8×8 cyclic AWG, having 8 input ports and 8 output ports. It is configured to receive 3 WDM US channel sub-sets of 8 WDM US channels at US input ports 1 to 3, which form the US input ports of the US optical routing apparatus. The second 8×8 cyclic AWG is also configured to distribute the 8 WDM US channels of each WDM US channel sub-set into 8 different wavelength bands, each wavelength band is output from a different output port of the second 8×8 cyclic AWG. Each wavelength band comprises 3 different WDM US channels. The band combiner is an 8:1 band combiner and comprises 8 input ports and the US output port 122. The band combiner is configured to combine the 8 wavelength bands, received at its 8 input ports, and output the combined WDM US channels from the US output port.

The WDM DS channels are 24 ODD channels (1, 3, 5, etc.) of a 48 channel wavelength grid and the WDM US channels are 24 EVEN channels (2, 4, 6, etc.) of the wavelength grid. The 24 WDM DS channels have a first channel spacing, for example 200 GHz, and the 24 WDM US channels also have the first channel spacing. The WDM DS channels in the DS channel sub-sets output from the DS optical routing apparatus 510, for example channels 1, 7, 13, 19, 25, 31, 37, 43 output from DS output port 112 (1), have a second channel spacing, larger than the first channel spacing, for example 600 GHz, and are non-contiguous DS channels. The WDM US channels in the US channel sub-sets received by the US optical routing apparatus 520, for example channels 2, 8, 14, 20, 26, 32, 38, 44 received at US input port 124 (1), also have the second channel spacing, and are non-contiguous US channels.

The optical combiner 530 is an optical interleaver 530. The optical interleaver is configured to interleave the WDM DS channels having the first channel spacing and the WDM US channels having the first channel spacing. The interleaved combined channels have a third channel spacing, lower than the first channel spacing, for example 100 GHz. In an embodiment, a fiber connected, for example to a baseband hub, carries 48 WDM channels, 100 GHz spaced. The 24 ODD channels and the 24 EVEN channels propagate in opposite directions. The optical interleaver 530 is a 100 GHz/200 GHz optical interleaver configured to split and combine the ODD and EVEN channels. The DS ODD channels, 200 GHz spaced, are directed to the 1:8 band splitter 512, which distributes them into 8 wavelength bands of contiguous channels, for example channels 1, 3 and 5, so that three contiguous DS ODD channels are present at each output port. The first cyclic 8×8 AWG 516 has a 200 GHz frequency spacing and a free spectral range, FSR, of 1.6 THz.

The first cyclic AWG routes the DS ODD channel ‘j’ received at input port ‘i’ on the right side to ouput port ‘k’ of its left side, where ‘k’ is obtained from equation 1:

$$k = {\vert \frac{j + 1}{2} + 8 - i \vert}_{8} + 1 \qquad Eq . l$$

where ‘i’ and ‘k’ range from [1;8] and j is an odd number that ranges from [1;47].

The 24 DS ODD channels are thus split by the first 8×8 cyclic AWG into three sub-sets, each sub-set consisting of 8 non-contiguous ODD channels, 600 GHz spaced. The three contiguous DS ODD channels received at each input port of the first 8×8 cyclic AWG 516 are routed to different DS output ports 112 (1), 112(2) and 112(3). This forms three DS channels sub-sets of non-contiguous channels, one at each DS output port.

In the upstream direction, the second 8×8 cyclic AWG 526 receives three different US channel sub-sets, each containing 8 non-contiguous US EVEN channels, 600 GHz spaced, at the three US input ports 124. The second 8×8 cyclic AWG has an FSR 100 GHz shifted from the FSR of the first 8×8 cyclic AWG. The second 8×8 cyclic AWG routes the US EVEN channels from the US input ports 124 to the 8 output ports on the right side, according to equation 2:

$$k = {\vert \frac{j}{2} + 8 - i \vert}_{8} + 1 \qquad Eq . 2$$

where ‘i’ and ‘k’ range from [1;8] and j is an even number and it ranges from [2;48].

The 8 resulting wavelength bands, each one consisting of three contiguous WDM US EVEN channels, 200 GHz spaced, are then combined by the 1:8 band combiner creating a set of 24 US EVEN channels, 200 GHz spaced.

Finally, the 24 US EVEN channels are sent upstream, for example, to the baseband hub, via the optical interleaver 530.

In an embodiment, the first optical filter device 516 is configured to distribute a first, ODD channel to a first DS output port, for example 112 (1), and the second optical filter device 526 is configured to receive a second, adjacent EVEN channel from an equivalent first US input port, for example 124 (1).

The ODN 500 is thus able to provide eight duplex (DS and US) channels to each of three nodes, as described below, which may for example be located at antenna sites or may be remote nodes of a passive optical network, PON. The ODN enables the use of contiguous channels in US and DS by transceivers connected to the nodes, so assuring low delay asymmetry in the two directions.

Corresponding embodiments also apply to the communication network 1000 described below.

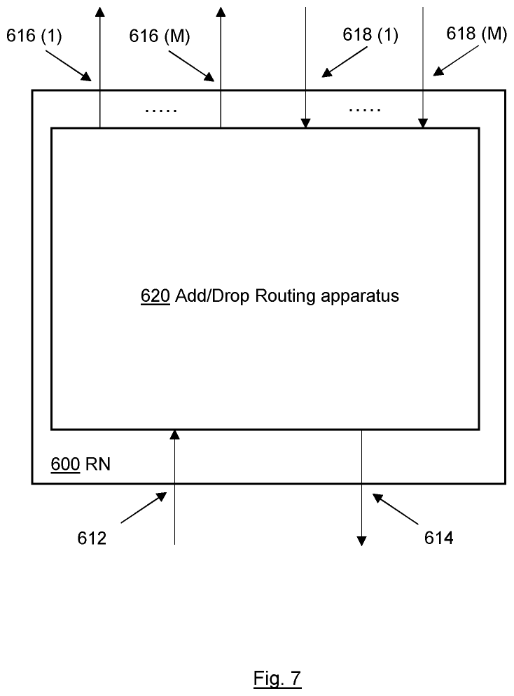

Referring to FIG. 7, an embodiment provides a communication network node 600 comprising a DS input port 612, a US output port 614, a plurality of drop ports 616, a plurality of add ports 618 and add/drop routing apparatus 620.

The DS input port 612 is for receiving a WDM DS channel sub-set of non-contiguous WDM DS channels. The add ports 618 are for receiving non-contiguous WDM US channels. The add/drop routing apparatus 620 are configured to route WDM DS channels from the DS input port to different drop ports 616, according to their wavelength, and is configured to route WDM US channels from different add ports to the US output port.

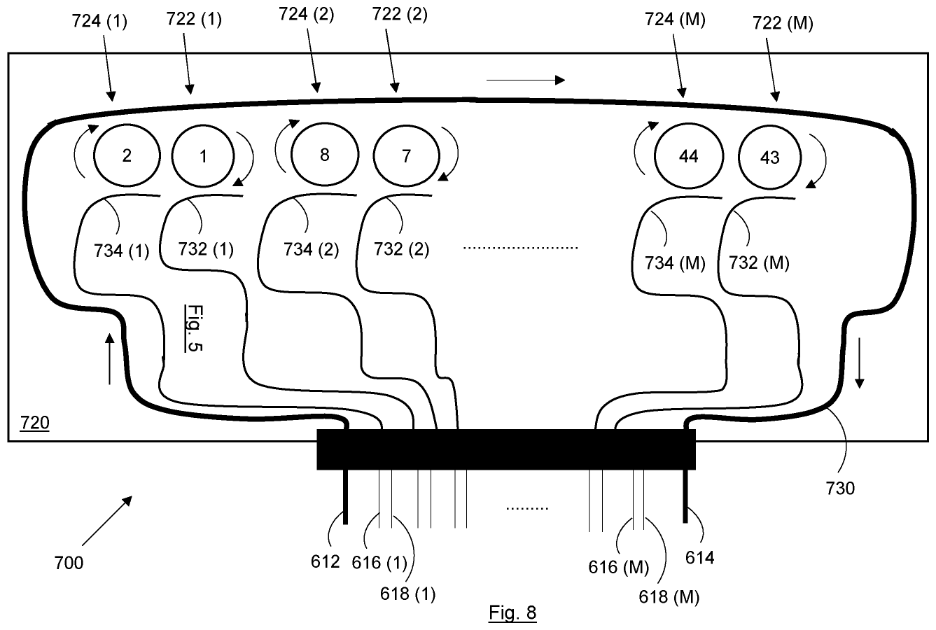

An embodiment provides a communication network node 700 in which the add/drop routing apparatus 720 comprises a plurality of optical drop couplers 722 and a plurality of optical add couplers 724, as illustrated in FIG. 8.

The optical drop couplers 722 are connected between the DS input port 612 and different drop ports 616. The optical drop couplers are configured to drop different DS channels to different drop ports, according to the channel wavelengths.

The optical add couplers 724 are connected between the US output port 614 and different add ports 618 The optical add couplers are configured to add different US channels, according to the channel wavelengths, received from different add ports.

In an embodiment, the optical drop couplers 722 and the optical add couplers 724 are micro-ring resonators, MRR.

The add/drop routing apparatus also comprises an optical bus waveguide 730, a plurality of drop waveguides 732 and a plurality of add waveguides 734. The optical bus waveguide 730 extends from the DS input port 612 to the US output port 614. Each drop waveguide 732 (1 . . . N) is connected to a different drop port and each add waveguide 734 (1 . . . N) is connected to a different add port. The optical drop couplers are configured to couple different DS channels, input into the optical bus waveguide from the DS input port 612, from the optical bus waveguide into different drop waveguides, according to the channel wavelengths. The optical add couplers are configured to add different US channels, received at different add ports, from different add waveguides into the optical bus waveguide for output from the US output port 614.

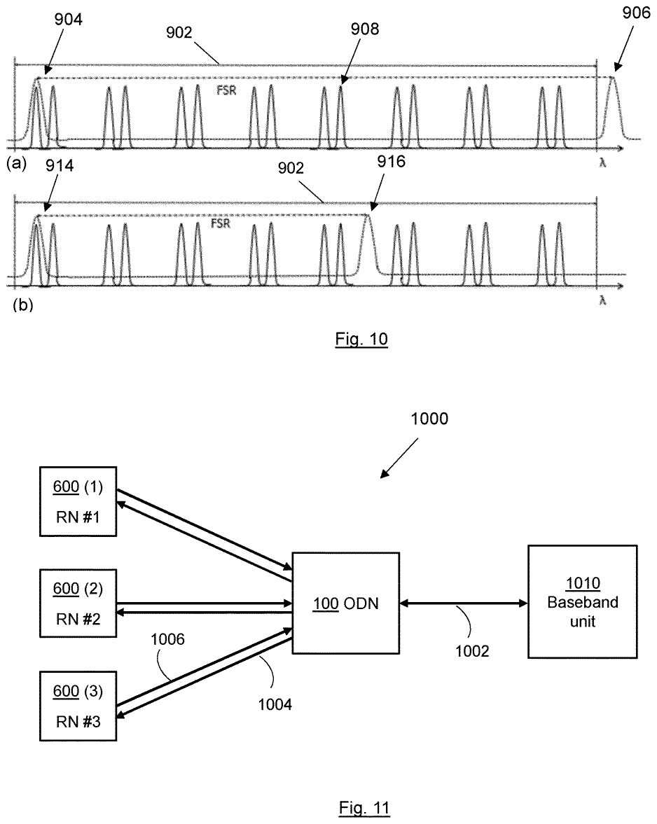

As illustrated in FIG. 10, the MRRs 722, 724 are configured to have wavelength responses comprising first resonance peaks 904, 914 at wavelengths of different DS channels or US channels, respectively. The MRRs are configured to have a free spectral range, FSR, such that the wavelength responses have second resonance peaks 906, 916 either at wavelengths outside a wavelength range 902 of the DS and US channels, as shown in FIG. 10 (1), or a wavelengths that fall between contiguous pairs 908 of DS channels and US channels, as illustrated in FIG. 10 (b).

The operating range of MRRs depends on their FSR, which is the wavelength (or equivalently, frequency) separation between two adjacent resonances. The resonant frequency of an MRR is related to the size (circumference) L of the ring as

$${λ}_{res} = \frac{L . {n}_{eff}}{m}$$

where n_{eff} is the effective refractive index of the ring and depends on the optical properties of its guiding materials. The free spectral range for a given λ is

$$FSR = \frac{{λ}^{2}}{{n}_{g} L}$$

where n_{g} is the group index.

A given wavelength resonance value can be achieved with different L values whereas for a given value of Δ the FSR is strongly dependent on the size of the ring and its material/design. Increasing the FSR means decreasing the size of the resonator or adopting a design of higher complexity. The add/drop routing apparatus 720 enables a relaxation of the FSR constraints since the add/drop channels reaching the node 700 are organized in well distanced pairs of channels. In fact, each pair of add/drop channels is separated by 500 GHz from the next one, therefore then it is possible allow for a second resonance of the resonator within the operating range, provided that the second resonance falls in the gap between two pairs of channels.

The resonance wavelength of an MRR may be tuned, for example by thermal tuning. The optical add couplers and the optical drop couplers may therefore be configured to add/drop specific wavelength channels and may advantageously be reconfigured to add/drop different wavelength channels. Use of MRRs as optical add couplers and optical drop couplers advantageously enables both wavelength selection and wavelength tuning functionality for each optical add/drop coupler.

In an embodiment, the add/drop routing apparatus 620 comprises a photonic integrated circuit.

In an embodiment, communication network node 700 is realized as part of a photonic chip containing silicon micro-ring resonators. The chip has a fibre connector at the DS input port which is attached to an input fibre for receiving DS channels from, for example, the ODN of FIG. 1, and an output fibre at the US output port to send the US channels to, for example, the ODN 100 of FIG. 1. A plurality, M, of fibre pairs, 616, 618, are connected to the drop ports and the add ports, for connection optical transceivers.

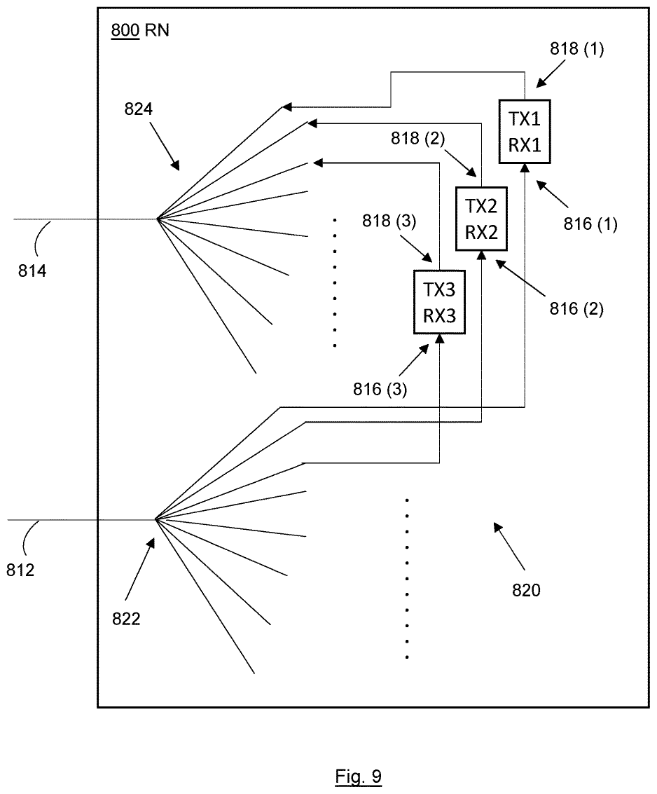

An embodiment provides a communication network node 800 in which the add/drop routing apparatus 820 comprises an optical splitter 822 and an optical coupler 824. The optical splitter connects the DS input port 812 to the drop ports 816. The optical coupler 824 connects the add ports 818 to the US output port 814, as illustrated in FIG. 9.

In an embodiment, the optical splitter 822 is a 1:8 optical splitter and the optical coupler 824 is an 8:1 optical coupler. The communication network node 800 of this embodiment is intended to be used with optical transceivers which have a tunable laser as the transmitter and a tunable filter at the receiver.

In the US direction, each tunable laser transmits at an assigned US channel wavelength. In the DS direction, a received optical signal is split equally into 8 parts, each of which is routed to a respective transceiver. The tunable filter at each transceiver then selects its assigned DS channel wavelength to be passed to the receiver. The tunable filter can be based on MRR or Bragg reflectors integrated in Silicon Photonics.

Referring to FIG. 11, an embodiment provides a communication network 1000 comprising a baseband hub 1010, a communication network ODN 100 and a plurality of communication network nodes 600. A single fibre optical link 1002 is provided connecting the baseband hub to the ODN. DS optical fibres 1004 are provided connecting DS output ports of the ODN to different nodes 600 and US optical fibres 1006 are provided connecting nodes 600 to different US input ports of the ODN 100.

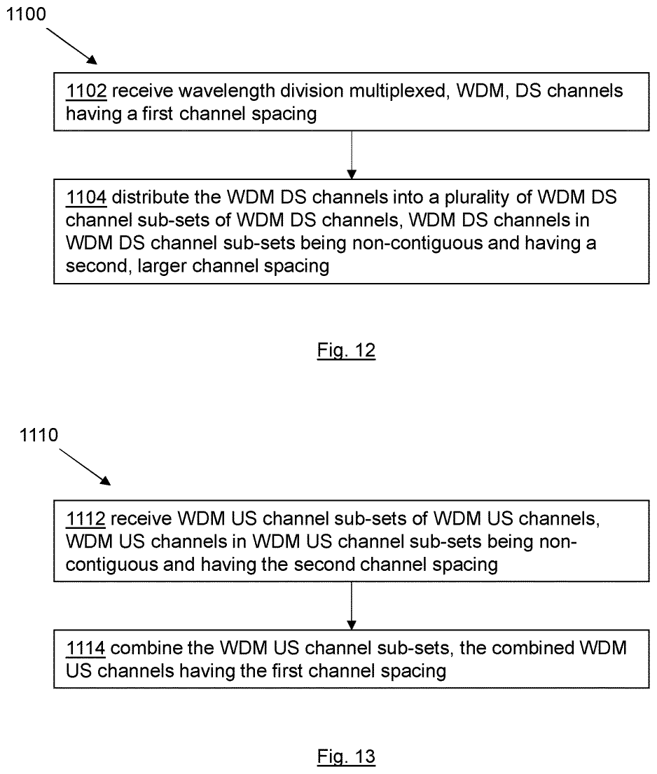

Referring to FIGS. 12 and 13, an embodiment provides a method of routing optical channels in a communication network.

The method comprises downstream operations 1100 of:
receiving 1102 WDM DS channels having a first channel spacing; and
distributing the WDM DS channels into a plurality of WDM DS channel sub-sets of WDM DS channels. The WDM DS channels in WDM DS channel sub-sets are non-contiguous and have a second, larger channel spacing.

The method comprises upstream operations 1110 of:
receiving 1112 WDM US channel sub-sets of WDM US channels. The WDM US channels in the WDM US channel sub-sets are non-contiguous and have the second channel spacing; and
combining 1114 the WDM US channel sub-sets. The combined WDM US channels have the first channel spacing.

In an embodiment, the method further comprises combining the WDM DS channels having the first channel spacing and the WDM US channels having the first channel spacing. The combined channels have a third channel spacing, lower than the first channel spacing.

1-20. (canceled)

21. A communication network optical distribution node (ODN), comprising:
downstream (DS) optical routing apparatus comprising a plurality of DS output ports and a DS input port for receiving wavelength division multiplexed (WDM) DS channels having a first channel spacing, the DS optical routing apparatus configured to distribute the WDM DS channels into a plurality of WDM DS channel sub-sets of WDM DS channels, the WDM DS channels in the WDM DS channel sub-sets being non-contiguous and having a second, larger channel spacing, and to route WDM DS channel sub-sets to different DS output ports; and
upstream (US) optical routing apparatus comprising a US output port and a plurality of US input ports for receiving WDM US channel sub-sets of WDM US channels, the WDM US channels in the WDM US channel sub-sets being non-contiguous and having the second channel spacing, wherein the US optical routing apparatus is configured to combine the WDM US channel sub-sets, the combined WDM US channels having the first channel spacing, and to route the combined WDM US channels to the US output port.

22. The ODN of claim 21, wherein the DS optical routing apparatus comprises:
a band splitter comprising the DS input port and configured to split the WDM DS channels into a first plurality of wavelength bands, each wavelength band comprising a second plurality of WDM DS channels; and
a first optical filter device comprising said second plurality of DS output ports and said first plurality of inputs ports for receiving different bands of said first plurality of wavelength bands, wherein the first optical filter device is configured to distribute the WDM DS channels of each wavelength band into the plurality of WDM DS channel sub-sets, and wherein each WDM DS channel sub-set is output from a different output port of the second plurality of DS output ports.

23. The ODN of claim 22, wherein the second plurality of WDM DS channels in each wavelength band are contiguous DS channels.

24. The ODN of claim 22, wherein the first optical filter device is a first cyclic arrayed waveguide grating (AWG).

25. The ODN of claim 24, wherein the band splitter is a 1:8 band splitter configured to receive 24 WDM DS channels and to split the 24 WDM DS channels into 8 wavelength bands of 3 WDM DS channels and wherein the first cyclic AWG is an 8×8 cyclic AWG configured to distribute the 3 WDM DS channels of each wavelength band into 3 WDM DS channel sub-sets, wherein the 3 WDM DS channel sub-sets are output from different output ports of 3 DS output ports of the 8×8 cyclic AWG.

26. The ODN of claim 21, wherein the US optical routing apparatus comprises:
a second optical filter device comprising said first plurality of output ports and said second plurality of US input ports for receiving the WDM US channel sub-sets, wherein the second optical filter device is configured to distribute the WDM US channels of each WDM US channel sub-set into different wavelength bands of said first plurality of wavelength bands, each wavelength band comprising said second plurality of WDN US channels having the first channel spacing, and wherein each wavelength band is output from a different output port of the first plurality of output ports; and
a band combiner comprising said US output port and said first plurality of input ports for receiving the wavelength bands, wherein the band combiner is configured to combine the wavelength bands, the combined US channels having the first channel spacing, and wherein the combined WDM US channels are output from the US output port.

27. The ODN of claim 26, wherein the second plurality of different WDM US channels in each wavelength band are contiguous US channels.

28. The ODN of claim 26, wherein the second optical filter device is a second cyclic arrayed waveguide grating (AWG).

29. The ODN of claim 28, wherein the second cyclic AWG is an 8×8 cyclic AWG configured to receive 3 WDM US channel sub-sets of 8 WDM US channels at 3 different US input ports, and wherein the 8×8 cyclic AWG is configured to distribute the 8 WDM US channels of each WDM US channel sub-set into 8 different wavelength bands, each wavelength band comprising 3 different WDM US channels, and wherein the band combiner is an 8:1 band combiner configured to combine the 8 wavelength bands and output the combined WDM US channels.

30. The ODN of claim 23, wherein the WDM DS channels are ODD channels of a wavelength grid and the WDM US channels are EVEN channels of the wavelength grid and wherein the first optical filter device is configured to distribute a first, ODD channel to a first DS output port and the second optical filter device is configured to receive a second, adjacent EVEN channel from an equivalent first US input port.

31. The ODN of claim 21, wherein the WDM DS channels are ODD channels of a wavelength grid and the WDM US channels are EVEN channels of the wavelength grid and wherein the ODN further comprises an optical combiner configured to combine the WDM DS channels having the first channel spacing and the WDM US channels having the first channel spacing, the combined channels having a third channel spacing, lower than the first channel spacing.

32. A communication network node comprising:
a downstream (DS) input port for receiving a wavelength division multiplexed (WDM) DS channel sub-set of non-contiguous WDM DS channels;
an upstream (US) output port;
a plurality of drop ports;
a plurality of add ports for receiving non-contiguous WDM US channels; and
add/drop routing apparatus configured to route WDM DS channels from the DS input port to different drop ports and configured to route WDM US channels from different add ports to the US output port.

33. The communication network node of claim 32, wherein the add/drop routing apparatus comprises a plurality of optical drop couplers connected between the DS input port and different drop ports, optical drop couplers configured to drop different DS channels to different drop ports, and a plurality of optical add couplers connected between the US output port and different add ports, optical add couplers configured to add different US channels received from different add ports.

34. The communication network node of claim 33, wherein the optical drop couplers and the optical add couplers are micro-ring resonators, MRR, and wherein the add/drop routing apparatus further comprises an optical bus waveguide extending from the DS input port to the US output port, a plurality of drop waveguides connected to different drop ports and a plurality of add waveguides connected to different add ports, and wherein the optical drop couplers are configured to couple different DS channels input into the optical bus waveguide from the DS input port from the optical bus waveguide into different drop waveguides and the optical add couplers are configured to add different US channels received at different add ports from different add waveguides into the optical bus waveguide for output from the US output port.

35. The communication network node of claim 34, wherein the WDM DS channels and WDM US channels have wavelengths within a channels wavelength range and wherein the MRRs are configured to have wavelength responses comprising first resonance peaks at wavelengths of different DS channels or US channels and wherein the MRRs are configured to have a free spectral range, FSR, such that the wavelength responses have second resonance peaks at one of wavelengths outside the channels wavelength range or wavelengths between wavelengths of contiguous pairs of DS channels and US channels.

36. The communication network node of claim 32, wherein the add/drop routing apparatus comprises an optical splitter connecting the DS input port to the drop ports and an optical coupler connecting the add ports to the US output port.

37. The communication network node of claim 32 wherein the add/drop routing apparatus comprises a photonic integrated circuit.

38. A method of routing optical channels in a communication network, the method comprising downstream operations of:
receiving wavelength division multiplexed (WDM) DS channels having a first channel spacing; and
distributing the WDM DS channels into a plurality of WDM DS channel sub-sets of WDM DS channels, WDM DS channels in WDM DS channel sub-sets being non-contiguous and having a second, larger channel spacing,
and the method comprising upstream operations of:
receiving WDM US channel sub-sets of WDM US channels, WDM US channels in WDM US channel sub-sets being non-contiguous and having the second channel spacing; and
combining the WDM US channel sub-sets, the combined WDM US channels having the first channel spacing.

39. The method of claim 37, further comprising combining the WDM DS channels having the first channel spacing and the WDM US channels having the first channel spacing, the combined channels having a third channel spacing, lower than the first channel spacing.

40. A communication network comprising:
a baseband hub;
a communication network ODN as claimed in claim 21;
a single fiber optical link connecting the baseband hub to the ODN;
a plurality of communication network nodes, each of the plurality of communication network nodes comprising a downstream (DS) input port for receiving a wavelength division multiplexed (WDM) DS channel sub-set of non-contiguous WDM DS channels, an upstream (US) output port, a plurality of drop ports, a plurality of add ports for receiving non-contiguous WDM US channels, and add/drop routing apparatus configured to route WDM DS channels from the DS input port to different drop ports and configured to route WDM US channels from different add ports to the US output port;
downstream (DS) optical fibers connecting DS output ports of the ODN to different communication network nodes; and
upstream (US) optical fibers connecting communication network nodes to different US input ports of the ODN.
